(19) United States
(12) Patent Application Publication
(10) Pub. No.: US 2008/0272915 A1
(43) Pub. Date: Nov. 6, 2008

(54) EQUIPMENT MONITORING SYSTEM AND METHOD

(75) Inventor: Roger DAY, Saint-Bruno (CA)

Correspondence Address: OGILVY RENAULT LLP (PWC), 1981 MCGILL COLLEGE AVENUE, SUITE 1600, MONTREAL, QC, H3A 2Y3, CA

(73) Assignee: PRATT & WHITNEY CANADA CORP., Longueuil (CA)

(21) Appl. No.: 11/744,488

(22) Filed: May 4, 2007

(51) Int. Cl. G08B 13/14

(52) U.S. Cl. 340/572.1

(57) ABSTRACT

There is provided a system for monitoring a replaceable unit. The system comprises a passive memory device attached to the replaceable unit forming part of an assembly such as an engine. The passive memory is for storing and for providing access to replaceable unit information comprising unit identification and usage information. The system may further comprise an event detector which may be embodied as an electronic engine controller (EEC) operatively connected to the engine, for accumulating the usage information related to the replaceable unit, and for communicating with the passive memory device to update the unit information stored in the passive memory device with the usage information.

### TECHNICAL FIELD

The invention relates generally to the monitoring and maintenance of powered and non-powered replaceable units and machinery located within a large installation, such as an industrial manufacturing line, an aircraft, a ship or any type of vehicle.

### BACKGROUND OF THE ART

Various types of engines and systems need constant or periodic inspection and monitoring. In aircraft applications for example, an Electronic Engine Control (EEC) records and provides monitoring and maintenance data, which is transmitted to onboard Health Usage Monitoring Systems (HUMS) or Data Transmission Units (DTU). The monitoring and maintenance data may be further downloaded to portable maintenance monitoring equipment upon landing of the aircraft. The type of inspection and maintenance actions needed for each replaceable unit within the installation or vehicle requiring periodic maintenance may vary depending on their operation time and whether the replaceable unit was subjected to any stress occurring during a specific event. In addition, it is highly desirable that each maintenance and inspection action be kept up-to-date and that any technical information pertaining to each replaceable unit is made readily available.

Accordingly, there is a need to provide an improved electronic-tag system and method for monitoring inspection, maintenance, and operation of each replaceable unit within a large installation such as an aircraft.

### SUMMARY

In one aspect, there is provided a system for monitoring a replaceable unit. The system comprises a passive memory device attached to the replaceable unit forming part of an assembly. The passive memory is for storing and for providing access to replaceable unit information comprising unit identification and usage information. The system further comprises an event detector operatively connected to the assembly, for accumulating the usage information related to the replaceable unit, and for communicating with the passive memory device to update the unit information stored in the passive memory device with the usage information.

In another aspect, there is provided a system for monitoring a replaceable unit. The system comprises means for storing and for providing access to replaceable unit information. The means for storing is passive and further adapted to be attached to the replaceable unit. The replaceable unit forms part of an assembly, and the unit information comprises unit identification and usage information. The system further comprises means for accumulating the usage information related to the replaceable unit and for communicating with the passive memory device to update the unit information stored in the passive memory device with the usage information, the means being operatively connected to the assembly.

In yet another aspect, there is provided a method for monitoring a replaceable unit. The method comprises: providing a passive memory device attached to the replaceable unit forming part of an assembly, the passive memory device being adapted to store and provide access to replaceable unit information comprising unit identification and usage information; providing an event detector operatively connected to the assembly; accumulating usage information related to the replaceable unit using data gathered from the event detector; and communicating the accumulated usage information to the passive memory device to update the unit information stored in the passive memory device with the usage information.

Further details of these and other aspects of the present invention will be apparent from the detailed description and figures included below.

In the present description, the expression “passive memory device” refers to a memory device containing no battery or internal power source to retain data. This definition is well accepted and known by those skilled in the art.

### BRIEF DESCRIPTION OF THE DRAWINGS

Reference is now made to the accompanying figures, in which:

FIG. 1 schematically illustrates a monitoring system;

FIG. 2 schematically illustrates the monitoring system of FIG. 1 within the context of an aircraft engine;

FIG. 3 is a flowchart which illustrates a monitoring method in relation to the monitoring system of FIGS. 1 and 2;

FIG. 4 schematically illustrates an alternative version of the monitoring system of FIGS. 1 and 2; and

FIG. 5 schematically illustrates another alternative version of the monitoring system of FIGS. 1 and 2.

### DETAILED DESCRIPTION

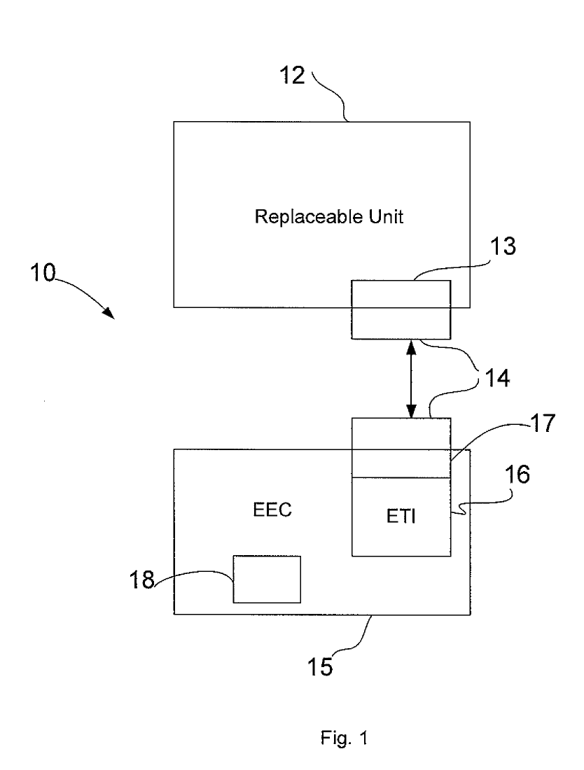

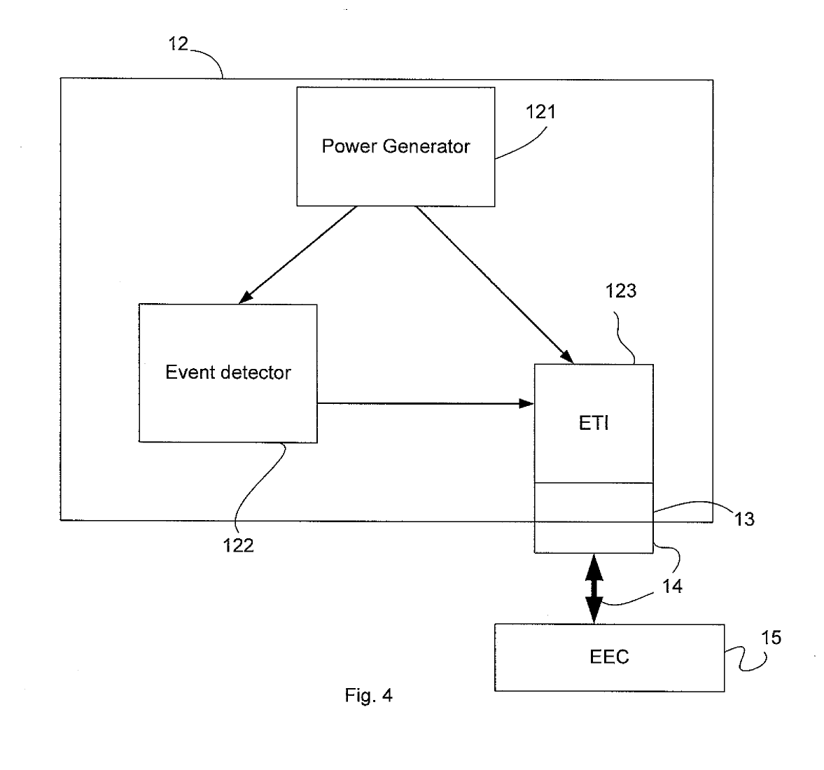

FIG. 1 schematically illustrates a monitoring system 10 wherein a replaceable unit 12 has a passive memory device 13, also known as a memory button or an electronic-tag. The replaceable unit 12 forms part of an assembly such as an engine, and is thus capable of being attached with other units forming the engine. The engine may be part of a larger assembly such as an industrial manufacturing line, an aircraft, a ship or any type of vehicle. The passive memory device 13 is further connected (either periodically or permanently) to a connecting device 14, for establishing an electrical contact with the passive memory device 13 and for enabling the communication between the passive memory device 13 and an event detector herein illustrated as an electronic engine control (EEC) device 15. An embodiment where the event detector forms part of the replaceable unit 12 is shown in FIG. 4 and discussed below. The connecting device 14 is herein illustrated with two probes attached together via a communication channel enabling either electrical or wireless communication.

The EEC device 15 is responsible for the control of the engine assembly. The EEC device 15 may have an elapsed time indicator (ETI) device 16, a memory device 17 attached to the connecting device 14, and a database 18.

The powerless memory device 13 has a non-volatile memory in which it is possible to record new data and access already stored data. Such data can be, for example, the replaceable unit's serial number or part number, a time since new or a time when replaced, a time since last maintenance (inspection or repair), and a time since overhaul or since last refurbishment. Other similar “times to” perform any type of action due on the unit can also be recorded. These times relate to usage information and are thus updated throughout the replaceable unit's lifecycle. The replaceable unit's technical information such as serial or part number usually remains fixed during the replaceable unit's entire functional life within the engine being monitored. The powerless memory device 13 can also be password protected and contain information such as the serial number of all the engines or the other units to which it has been connected in its lifecycle. Any other relevant maintenance information, such as maintenance due schedule and a maintenance history can also be recorded, accessed and updated in accordance with the monitoring system herein detailed.

The connecting device 14 is characterized by having two probe-like devices engaged on each one of the two memory devices 13 and 17 of the replaceable unit 12 and the EEC device 15 respectively. The probe-like devices are capable of reading and writing to each of the two memory devices 13 and 17 via a direct electrical connection or a wireless connection. Hence, the connecting device 14 permits the communication between the replaceable unit's passive memory device 13 and the EEC device 15. Communication between the two probe-like devices of the connecting device 14 can be achieved either through electrical wiring connections or through wireless communication. Alternatively, the connecting device 14 could simply be a connector. In the case where memory device 13 is passive, the connecting device 14 shall be powered from the EEC device 15 or the memory device 17 on the EEC.

The EEC device 15 may be powered by the engine it controls. The EEC device 15 is capable of recording and detecting events concerning the engine in a database 18. For example, when the engine is activated, a control event is recorded and an event signal is sent to the ETI device 16. The EEC device 15 may be accessed by any user stations needing information on the control events and replaceable unit information. The EEC device 15 can be password protected.

The ETI device 16 is a device capable of counting an elapsed time between two given events, upon receiving given event signals from the EEC 15 whenever given events occur. Once an elapsed time is determined between given events, it is sent to database 18 or to the memory device 17, and subsequently to whichever passive memory device 13 of a replaceable unit is affected by such an event.

Memory device 17 is similar to passive memory device 13, although it is powered by the power of the EEC 15, and therefore is not necessarily passive.

Control events (or simply “events”) also can be, for example, the number of engine stalls, occurrences when the engine's temperature is not within a prescribed range, or any other event under the existing control of the EEC device 15 such as when weight is felt on the wheels (i.e., “weight-on-wheels”) in the case of an aircraft.

A list of all the replaceable units 12 forming part of the engine being monitored and controlled by the EEC device 15 is stored in database 18. A log of control events and activation history concerning each replaceable unit 12 is created and stored in database 18. In other words, control event information and elapsed times for each event are recorded for the replaceable unit 12 being affected by the events. The information related to each replaceable unit 12 is periodically sent to its passive memory device 13 and stored there.

For example, a start-up signal is sent to the ETI device 16 upon activation of the engine under the control of the EEC device 15, and a shut-down signal is sent to the ETI device 16 when the engine is shut-down. The ETI device 16 counts the time between the reception of these two signals. An elapsed time corresponding to the engine's activation time or run-time is therefore measured. This elapsed time is recorded in the database 18 for each related replaceable unit 12. The passive memory devices 13 of each replaceable unit 12 affected by the activation of the engine are updated with the recorded elapsed time. A total activation time for each replaceable unit 12 is thus stored in each of the passive memory devices 13. Updates can be performed after each activation periods or during the activation time, as in a real-time fashion. Certain information stored on the passive memory devices 13 can always be found at a given memory address for example, such that specific information can be retrieved by accessing the given address. Information stored in a passive memory device 13 can be read or accessed by first energising the device 13 such that the desired information can be sent through the connecting device 14 to the requesting party. For example, the ECC device 15 can sequence a given pattern for reading or writing to each of the replaceable units 12 memory devices 13. The sequence can vary according to specific information demands and update requirements.

Similarly, the EEC device 15 can maintain a log of occurrences when a given parameter being monitored by the EEC device 15 exceeds a given threshold value. For example, each time the engine's temperature or pressure level exceeds a given safe temperature or pressure range, an event is recorded in database 18. Other parameters may also be monitored, such as vibration levels, flow of air or a liquid, and voltages. The rate of change of the previously listed given parameters may also be considered as an event to be recorded. When an event is known to affect a given replaceable unit 12, the log of events for the given replaceable unit 12 is updated with the information concerning the event.

Still referring to FIG. 1, the EEC device 15 sets a flag or an alarm that maintenance is due on a specific replaceable unit whenever a comparison of the updated unit information with the maintenance schedule stored in a passive memory device reveals that maintenance is due. Similarly, whenever maintenance is performed on a given replaceable unit 12, the EEC device 15 updates the time of the last maintenance stored in the passive memory device 13 of the corresponding replaceable unit. The time since the last maintenance is then updated each time the activation time is being updated. The time to a replaceable unit's overhaul and the time since a replaceable unit's overhaul are updated in a similar manner.

Whenever a replaceable unit is replaced, the part number or serial number of the new replaceable unit, stored in the replaceable unit's passive memory device 13 is sent to the EEC device 15. The EEC device 15 can thus also determine if the new replaceable unit being installed is compatible with the engine or the other replaceable units to which it is to be connected and with which they function by comparing the new part number or serial number stored in the new replaceable unit's passive memory device 13 with a compatibility list of the engine stored either database 18 or memory device 17.

Additionally, the passive memory device 13 of the replaceable unit 12 can be interrogated independently of the EEC device 15, by any other reading device, and thus even when the unit 12 is removed from the engine or assembly. This allows for the reading or writing of related usage information wherever the replaceable unit is located.

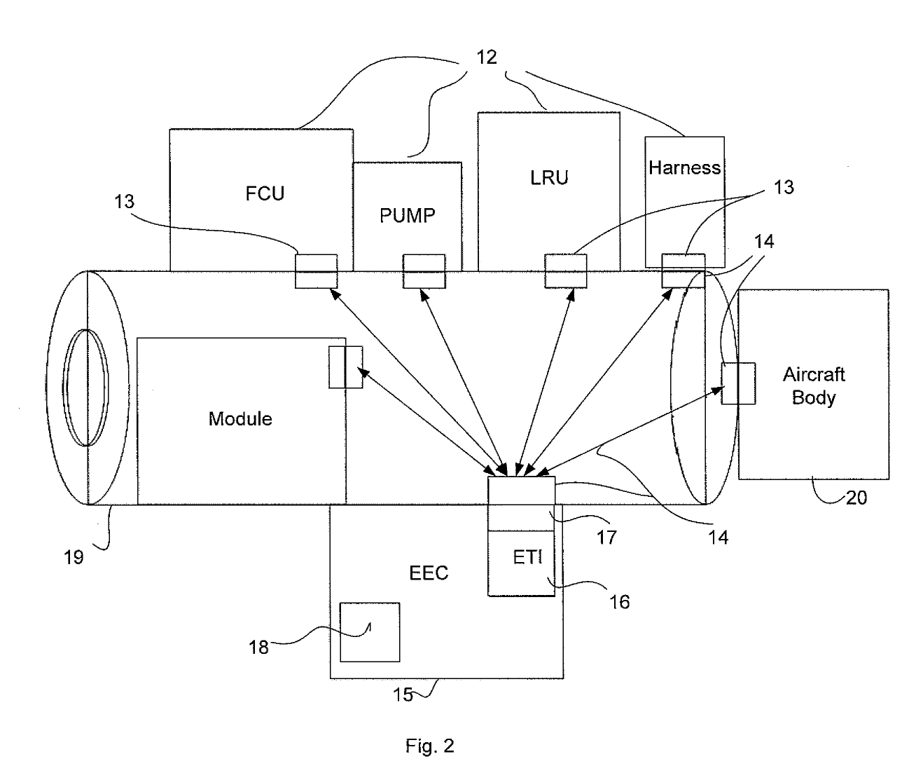

FIG. 2 schematically illustrates the monitoring system of FIG. 1 within the context of an engine 19 installed in an aircraft having an aircraft body 20. Replaceable units 12 can be mechanical parts, flight control units (FCU), engine pumps, any line replaceable units (LRUs), electrical wiring harnesses, and any other modules within the engine 19 and the rest of the aircraft's body 20. The monitoring system illustrated is most valuable for non-powered replaceable units however.

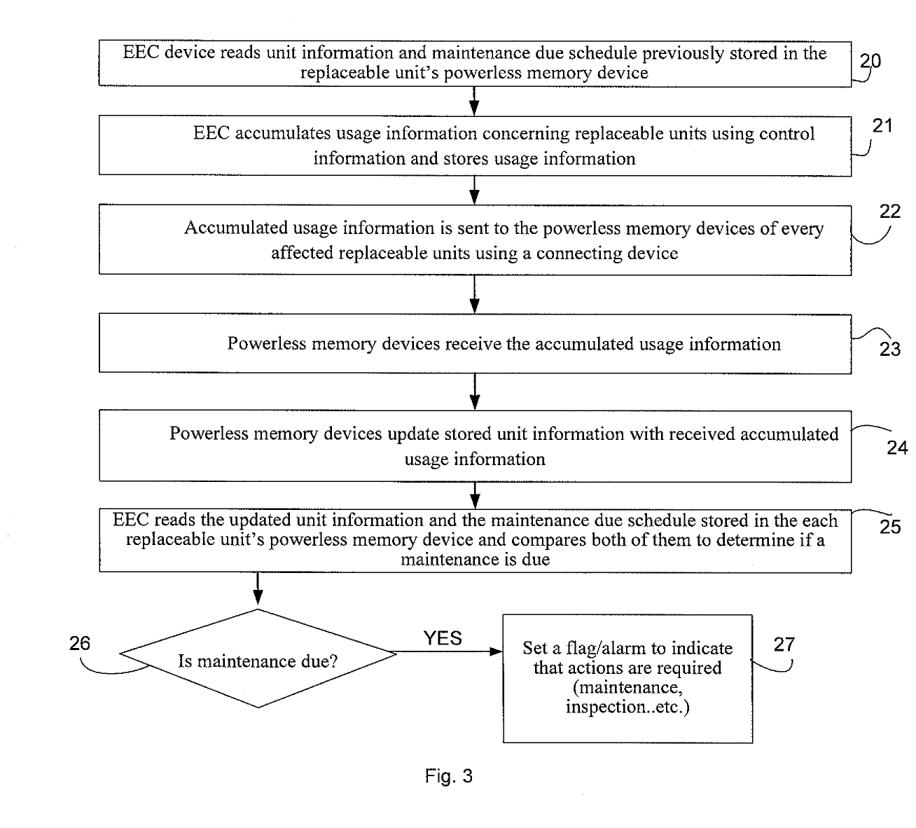

FIG. 3 is a flowchart which illustrates a monitoring method in relation to the monitoring system of FIGS. 1 and 2. In step 20, the EEC device 15 reads unit information and maintenance due schedule previously stored in the replaceable unit's 12 passive memory device 13. This step can be omitted and be part of step 25 below.

In step 21, the EEC device 15 accumulates usage information concerning replaceable units 12 forming part of an engine such as an aircraft engine 19 using control information related to the engine 19. The accumulated usage information is stored in either or both database 18 and memory device 17 of the EEC device 15, according to each replaceable unit 12 involved.

In step 22, the accumulated usage information is sent to each of the passive memory devices 13 of every replaceable unit 12 affected by the control information of the EEC device 15 via connecting devices 14.

In step 23, the replaceable units' passive memory devices 13 receive, via the connecting device 14, the accumulated usage information.

In step 24, each of the passive memory devices 13 updates its stored replaceable unit information with the received accumulated usage information.

In steps 25 to 27, the EEC device 15 reads the updated replaceable unit information and the maintenance due schedule stored in each of the replaceable unit's passive memory devices 13 and compares them to determine whether maintenance is due or not. If maintenance is due, a flag or an alarm is turned on, or a data bit can be set or a signal can be sent to the EEC device 15, such that proper actions may be taken by maintenance and inspection personnel.

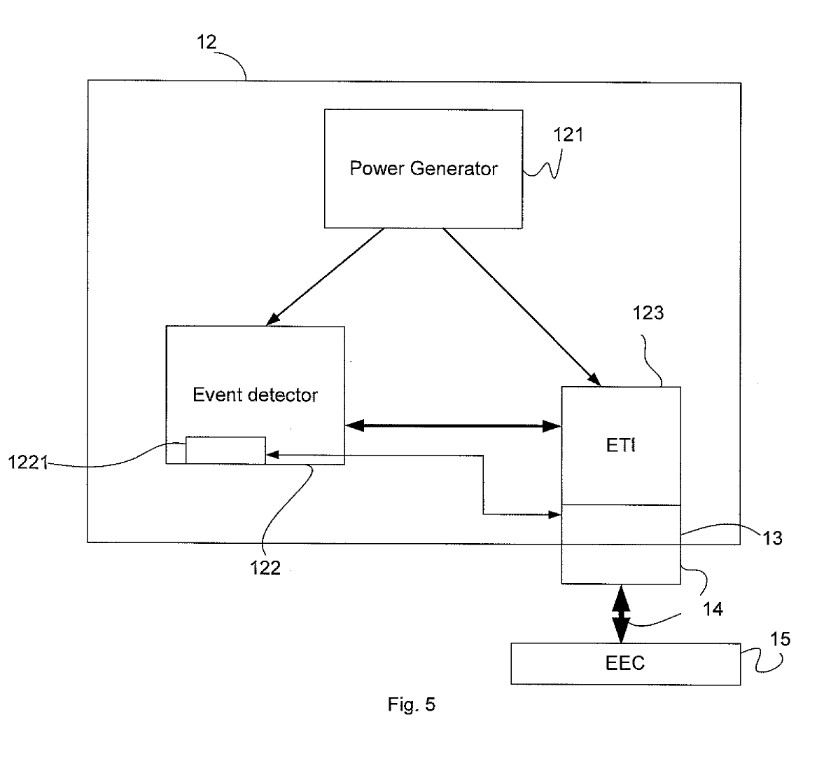

FIGS. 4 and 5 present alternative versions of the monitoring system as illustrated in FIGS. I and 2, wherein the replaceable units 12 being adapted to provide power to their respective passive memory devices 13, and record data related to events occurring internally or within their own body structure.

More specifically, FIG. 4 illustrates an alternative version of a replaceable unit 12 capable of generating enough power to energize on-board intelligent devices. A power generator 121 capable of generating power from the replaceable unit's own mechanical activity, or preferably from any environmental conditions, sends power to an internal event detector 122 and an elapsed time indicator (ETI) device 123, also both located in the replaceable unit 12.

The environmental conditions used by the power generator 121 to generate power can be, for example, vibrations present when the replaceable unit is mechanically functioning, or when a nearby engine is activated. Other environmental factors such as pressure pulses and liquid flows can be used by the media power generator 121. Such an internal power generation provides the ability to add intelligence and additional smart features to both the passive memory device 13 and the replaceable unit 12. In this way, a replaceable unit 12 can independently monitor events occurring within its own structure and maintain a log of events stored within its own now power-enabled passive memory device 13. In such a case, the EEC device 15 may not be needed.

For example, a replaceable unit's self-generated power is used to power the timer of the ETI device 123, the internal event detector 122, and the passive memory device 13. Sensors within the internal event detector 122 are thus capable of detecting events and take relevant measurements. The detected events and measurements are used to activate the ETI device 123 and in turn update replaceable unit information stored in the passive memory device 13. The detected events and other measurements can also trigger counters to count occurrences of given events.

For example, whenever an event occurs, a signal is sent to the ETI device 123, such that an elapsed time can be measured, and a log of events according to their detailed measurements and times is created and stored in the passive memory device 13. Other features such as logging a time of use, or a time when the replaceable unit is in function, detecting when a given parameter being measured exceeds a set threshold, detecting any undesirable agent or chemical compound contamination within the replaceable unit 12 can be achieved. Since the passive memory device 13 can use the self-generated power, the execution of small software routines stored within the memory device 13 by an on-board processor (not shown), is made possible. An alarm or data bit can thus be turned on by the replaceable unit 12 itself whenever a maintenance is due or, for example, whenever a given specific event or measurement occurs within the body of the replaceable unit 12.

Although not necessary due to internal self-monitoring capabilities as detailed above, the passive memory device 13 can send updated unit information such as the log of events and any alarm to the memory device 17 of a related EEC device 15 of an engine 19 (refer to FIGS. 1 and 2) such that proper actions may be taken. Either one of the EEC 15 or the on-board processing power can prompt a user station to alert any personnel responsible of the equipment's proper functioning.

FIG. 5 is similar to FIG. 4, although additional features are introduced. The internal event detector 122, in addition to simply taking measurements to detect events, is adapted to acquire and record digital pictures (or images) of events, hardware or components located within the replaceable unit, and collect any other relevant measurements. The collected evidence is then stored in a storage device 1221 or directly in the memory device 13. The evidence collected and stored is accessible via the memory device 13. Actuators (not shown) can also be controlled by the onboard processing power capabilities of the replaceable unit 12 to enable the automatic performance of proper actions upon the recognition of an event.

For example, when an event is detected by the internal event detector 122, evidence is recorded and stored. An event start and an event stop signal are sent to the ETI device 123. The ETI device 123 calculates an elapsed time during which the event occurs. The ETI device 123 then sends elapsed times to the passive memory device 13, wherein a log of events is recorded. Evidence data can be accessed by the EEC device 15 of a related engine through the memory devices 13 and 17, and through the connecting device 14 in order to determine whether an action should be performed or not. Alternatively, this decision can be taken by the replaceable unit's on-board processor. The on-board processor (not shown) can be in the ETI device 123, internal event detector 122 or anywhere in the replaceable unit 12. A diagnosis is subsequently generated by the processor and results from such event monitoring. The amount of wear and the verification of the replaceable unit's 12 general health can also be monitored

In a situation where an action is required upon the detection of a given event, an “action required” signal generated by the processor or ETI device 123 is sent back to the internal event detector 122. The power necessary to perform the “actions required” by actuators is provided by the on-board power generator 121. Actions are performed by actuators, for example, which can perform basic maintenance tasks without the intervention of any personnel or maintenance crew. Actions may also be performed whenever the measure of the wear of a device within the replaceable unit 12 requires compensation for example. The actuators are also capable of moving components within the replaceable unit 12 or the replaceable unit 12 itself if required. Other actions, such as removing sludge build-ups or un-clogging on-board filters are also possible. Multiple event detecting devices located in a same replaceable unit 12 or in another replaceable unit 12 can communicate with each other, directly or via each unit's memory device 13. This allows for the coordination of actions performed throughout the engine or installation.

Those skilled in the art will recognize that several other monitoring or actuation options can be performed by the above-described system and method, and that the options herein describes are given as examples. It is thus understood that several other embodiments may be implemented and fall within the scope of the system and method herein described.

What is claimed is:

1. A system for monitoring a replaceable unit, said system comprising:
a passive memory device attached to said replaceable unit forming part of an assembly, said passive memory device for storing and for providing access to replaceable unit information comprising unit identification and usage information; and
an event detector operatively connected to said assembly, for accumulating said usage information related to said replaceable unit, and for communicating with said passive memory device to update said unit information stored in said passive memory device with said usage information.

2. The system of claim 1, further comprising a probe installed on said assembly, for providing an electrical contact with said passive memory device.

3. The system of claim 1, further comprising a communication channel for enabling said communication between said passive memory device and said EEC, said communication channel being at least one of an electrical connection and a wireless connection.

4. The system of claim 1, wherein said event detector further comprises an elapsed time indicator (ETI) for counting elapsed time between given events, thereby accumulating said usage information.

5. The system of claim 4, wherein the assembly comprises an engine and the event detector comprises an electronic engine controller (EEC).

6. The system of claim 5, wherein said given events comprise at least one of an activation and a shut-down of the engine, an engine stall, a temperature out of a given range, a pressure out of a given range, a flow out of a given range, a vibration out of a given range, a rate of change of a temperature, a rate of change of a pressure, a rate of change of a flow, a rate of change of a vibration and the presence of weight on wheels.

7. The system of claim 1, wherein the passive memory device comprises a plurality of passive memory devices and said replaceable unit comprises a plurality of replaceable units each of said memory devices attached to one of said plurality of replaceable units.

8. The system of claim 1, wherein said replaceable unit further comprises a power generator connected to said passive memory device, said power generator adapted to generate power from at least one of vibrations, pressure pulses, temperature gradient, temperature and liquid flow.

9. The system as in claim 8, wherein said assembly comprises an engine and said replaceable unit further comprises an internal event detector for determining the occurrence of an event, said event comprising at least one of an activation and a shut-down of the engine, an engine stall, a measured temperature, a detected pressure level, a given parameter out of range, a rate of change of a given parameter and the presence of a chemical agent.

10. The system as in claim 9, wherein said replaceable unit further comprises at storage device for storing information on said occurrence of said event.

11. The system as in claim 10, wherein said information on said occurrence of said event comprises captured images of components located within the replaceable unit.

12. The system as in claim 1l wherein said replaceable unit further comprises an actuator device for performing a task upon the detection of said event, said task comprising at least one of moving internal components, removing sludge build-ups and unclogging filters.

13. A system for monitoring a replaceable unit, said system comprising-
means for storing and for providing access to replaceable unit information, said means for storing and providing access being passive and further adapted to be attached to said replaceable unit, said replaceable unit forming part of an assembly, and said unit information comprising unit identification and usage information; and
means for accumulating said usage information related to said replaceable unit, and for communicating with said passive memory device to update said unit information stored in said passive memory device with said usage information, said means for accumulating and for communicating being operatively connected to said assembly.

14. A method for monitoring a replaceable unit, said method comprising:
providing a passive memory device attached to said replaceable unit forming part of an assembly, said passive memory device being adapted to store and provide access to replaceable unit information comprising unit identification and usage information;
providing an event detector operatively connected to said assembly;
accumulating usage information related to said replaceable unit using data gathered from said event detector; and
communicating said accumulated usage information to said passive memory device to update said unit information stored in said passive memory device with said usage information.

15. The method as in claim 14, further comprising said event detector comparing said updated unit information with a maintenance due time stored in said passive memory device.

16. The method as in claim 15, further comprising said event detector setting an alarm signal if said step of comparing reveals a correspondence between said maintenance due time and said updated unit information.

17. The method as in one of claims 14, wherein said assembly comprises an engine and wherein providing said event detector comprises providing an electronic engine controller EEC for recording and providing monitoring and maintenance data.
